(19) United States
(12) Patent Application Publication
(10) Pub. No.: US 2011/0114544 A1
(43) Pub. Date: May 19, 2011

(54) APPARATUS FOR TRANSPORTING ARTICLES

(75) Inventor: ARMIN ZIMMERMANN, KONSTANZ (DE)

(73) Assignee: SIEMENS AKTIENGESELLSCHAFT, MUENCHEN (DE)

(21) Appl. No.: 12/946,026

(22) Filed: Nov. 15, 2010

(30) Foreign Application Priority Data
Nov. 13, 2009 (DE) 10 2009 053 068.1

(51) Int. Cl. B07C 5/04; B07C 5/06

(52) U.S. Cl. 209/656

(57) ABSTRACT

An apparatus for transporting articles has at least one transporting line and a dividing-up configuration, which is connected to the transporting line and is intended for dividing up the articles onto at least two downstream subsidiary lines. Accordingly the dividing-up configuration has a first gripping configuration, which grips and rotates all articles having a predetermined minimum height. Located downstream of the first gripping configuration—as seen in the movement direction—is a second gripping configuration, which grips such articles as have passed through the first gripping configuration without being gripped. A distance between the first gripping configuration and the second gripping configuration is dimensioned such that the articles gripped by the first gripping configuration are rotated out of the gripping region of the second gripping configuration before they pass through the same.

### CROSS-REFERENCE TO RELATED APPLICATION

This application claims the priority, under 35 U.S.C. §119, of German application DE 10 2009 053 068.1, filed Nov. 13, 2009; the prior application is herewith incorporated by reference in its entirety.

### BACKGROUND OF THE INVENTION

### Field of the Invention

The invention relates to an apparatus for transporting articles, in particular flat items of mail, having at least one transporting line and a dividing-up configuration, which is connected to the transporting line and is intended for dividing up the articles onto at least two downstream subsidiary lines.

Such an apparatus is known from published, non-prosecuted German patent application DE 10 2006 048 422 A1. In the case of the previously known apparatus, the articles have their magnitude sensed by a measuring module. In dependence on their respective height, the articles are distributed between different subsidiary lines by a control unit, with the aid of diverters.

Published, non-prosecuted German patent application DE 10 2008 007 373 A1 discloses a further apparatus which is intended for transporting articles and in which a transporting line has arranged downstream of it a dividing-up configuration for dividing up the articles onto at least two downstream subsidiary lines. It is also the case with this apparatus that the articles are divided up onto the subsidiary lines with the aid of a measuring module which senses the magnitude of the articles and then assigns the latter to the respective subsidiary lines.

German patent DE 44 37 114 C1, corresponding to U.S. Pat. No. 5,899,318, discloses an apparatus for transporting flat items of mail, having a covering-belt system containing a lower belt and an upper belt, between which items of mail are conveyed. The apparatus contains main drums and secondary drums in order to avoid differences in speed between the lower belt and upper belt during deflection of the covering belt.

Published, non-prosecuted German patent application DE 40 22 160 A1, corresponding to U.S. Pat. No. 5,261,521, discloses an apparatus for turning small items, in particular packets on a transporting belt. This apparatus has a tilting apparatus by which the small items can be turned through 90°.

German patent DE 197 57 717 C1, corresponding to U.S. Pat. No. 6,186,312, discloses a configuration which is intended for turning flat items of mail and in which a directing configuration is provided in relation to an oblique side belt such that the directing configuration tilts the items of mail onto the oblique side belt and, in the process, subjects the items of mail, at most, to small forces directed counter to the carry-along forces.

### SUMMARY OF THE INVENTION

It is accordingly an object of the invention to provide an apparatus for transporting articles which overcomes the above-mentioned disadvantages of the prior art devices of this general type, in which the operation of dividing up the articles onto at least two downstream subsidiary lines is realized particularly straightforwardly and cost-effectively.

With the foregoing and other objects in view there is provided, in accordance with the invention an apparatus for transporting articles. The apparatus contains at least one transporting line, at least two subsidiary lines, and a dividing-up configuration connected to the transporting line and intended for dividing up the articles onto the at least two subsidiary lines disposed downstream of the dividing-up configuration. The dividing-up configuration has a first gripping configuration for gripping and rotating all of the articles having a predetermined minimum height and is disposed downstream of the first gripping configuration. As seen in a movement direction, is a second gripping configuration configured to grip the articles that have passed through the first gripping configuration without being gripped. A distance between the first gripping configuration and the second gripping configuration is dimensioned such that the articles gripped by the first gripping configuration are rotated out of a gripping region of the second gripping configuration before they pass through the second gripping configuration.

A transporting line moves articles in a movement direction. A dividing-up configuration is configured to divide up articles onto at least two downstream subsidiary lines. According to the invention, it is provided that the dividing-up configuration has a first gripping configuration, which grips and rotates all articles having a predetermined minimum height. Located downstream of the first gripping configuration—as seen in the movement direction—is a second gripping configuration, which grips such articles as have passed through the first gripping configuration without being gripped. A distance between the first gripping configuration and the second gripping configuration is dimensioned such that the articles gripped by the first gripping configuration are rotated out of the gripping region of the second gripping configuration before they pass through the same.

A significant advantage of the apparatus according to the invention should be considered that of making it possible for the operation of dividing up the articles onto the at least two downstream subsidiary lines to be executed purely mechanically by the two gripping configurations. There is no need, in the case of the apparatus according to the invention, for properties of the articles, for example, the height, thickness, width or the weight, to be measured. Nor is it necessary to provide a control configuration in order for the articles to be separated out in dependence on measured values recorded. In the case of the apparatus according to the invention, the operation of dividing up the articles can be executed exclusively mechanically, to be precise by virtue of high articles being rotated away by a first gripping configuration such that these articles are rotated out of the gripping region of the second gripping configuration and thus cannot be gripped by the second gripping configuration.

According to a preferred configuration of the apparatus, it is provided that the first gripping configuration has a first covering-belt system with a first supporting belt and a first covering belt, wherein the first covering-belt system is installed at a height which corresponds to the minimum height, and wherein all articles having the predetermined minimum height are gripped by the two belts of the covering-belt system. Such an apparatus can be realized with particularly low outlay.

The first supporting belt and the first covering belt are preferably twisted by a predetermined angle of rotation, and therefore the articles gripped by them can be rotated by them through this angle of rotation.

As an alternative and/or in addition, the first gripping configuration may have a directing element, which executes, or at least assists, the operation where the articles gripped by the first gripping configuration are rotated out of the gripping region of the second gripping configuration. Such a directing element is preferably arranged in its entirety, or at least in part, between the first gripping configuration and the second gripping configuration.

The second gripping configuration preferably has a second covering-belt system with a second supporting belt and a second covering belt, in order to feed the “leftover” articles into the associated subsidiary line.

The second supporting belt and the second covering belt are preferably twisted by a predetermined second angle of rotation, in order that the articles gripped by them are rotated by them through the second angle of rotation.

The second angle of rotation and the first angle of rotation are preferably identical, or at least similar; this advantageously means that the articles transported in the subsidiary lines are aligned at least approximately similarly and/or more or less parallel to one another.

The dividing-up configuration is preferably provided with a free-running region, which is arranged upstream of the first gripping configuration—as seen in the movement direction. For example the supporting belts of the two covering-belt systems can extend into the free-running region in order to carry the articles there without any covering belt being required.

For example at least one pivotable pressure-exerting element may be arranged in the free-running region, and the pressure-exerting element pushes the articles onto at least one of the two supporting belts.

The at least two downstream subsidiary lines are preferably connected to a further, downstream transporting line, into which they feed the rotated articles. The subsidiary lines are preferably of equal length; in this case, the distance between the articles once the latter have been fed into the further transporting line corresponds to the distance in the transporting line upstream of where articles are fed into the dividing-up configuration.

Other features which are considered as characteristic for the invention are set forth in the appended claims.

Although the invention is illustrated and described herein as embodied in an apparatus for transporting articles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1-3 are diagrammatic, plan views showing an exemplary embodiment of an apparatus according to the invention for transporting articles;

FIG. 4 is a diagrammatic, cross-sectional view of the apparatus according to FIGS. 1 to 3; and

FIG. 5 is a diagrammatic, cross-sectional view of the apparatus according to FIGS. 1 to 3 in a different cross section.

### DESCRIPTION OF THE INVENTION

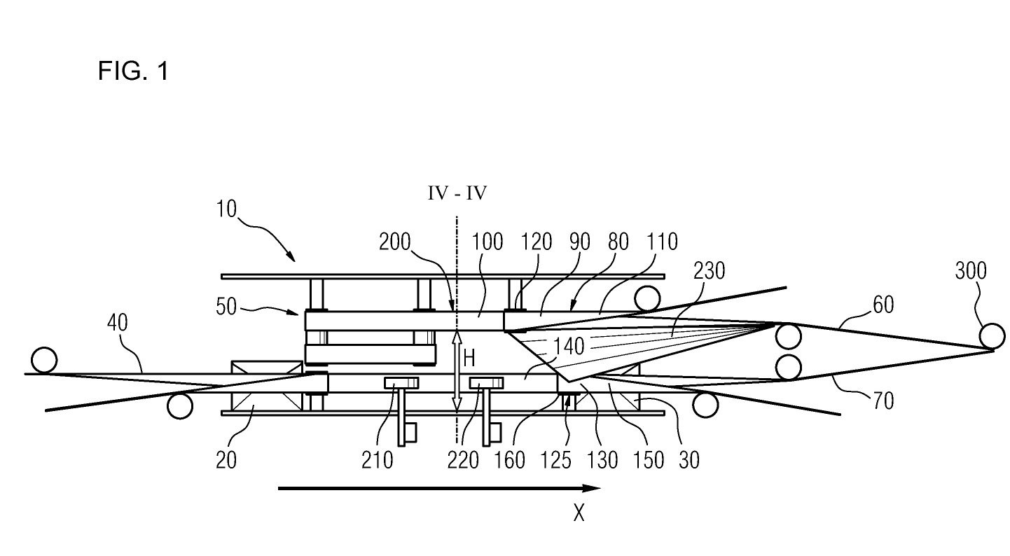

In the figures, for the sake of clarity, identical or comparable components are always designated using the same designations. Referring now to the figures of the drawing in detail and first, particularly, to FIG. 1 thereof, there is shown an apparatus 10 for transporting flat articles, which may be, for example, letters or packets or the like. The articles are indicated in FIG. 1 by designations 20 and 30.

The apparatus 10 contains a transporting line 40, which has arranged downstream of it a dividing-up configuration 50 for dividing up the articles onto at least two downstream subsidiary lines. The two subsidiary lines are indicated in FIG. 1 by designations 60 and 70. The subsidiary line 60, which is the upper subsidiary line in FIG. 1, serves in this case for receiving high articles which reach, or exceed, a predetermined minimum height H. The subsidiary line 70, which is the lower subsidiary line in FIG. 1, is used for all the rest of the articles, that is to say such articles which do not reach the minimum height H.

As is evident in FIG. 1, the dividing-up configuration 50 has a first gripping configuration 80, which is provided with a covering-belt system 90—referred to hereinbelow as first covering-belt system. The covering-belt system 90 (“pinch belt system”) contains a plurality of endless conveying belts which are guided around in each case at least two rollers and transport flat articles in an upright state such that the articles are gripped without slipping. The first covering-belt system 90 contains a first supporting belt 100 and an associated first covering belt 110. The first covering belt 110 is deflected by a first deflecting roller 120.

The first deflecting roller 120 of the first covering-belt system 90 is installed such that all articles having the predetermined minimum height H are gripped by the first deflecting roller 120 and fed into the first covering-belt system 90. Articles which reach at least the predetermined minimum height H are thus fed by the first deflecting roller 120 into the subsidiary line 60, which is the upper subsidiary line in FIG. 1.

As is also evident in FIG. 1, the first supporting belt 100 and the first covering belt 110 are twisted by an angle of rotation of approximately 90°, and therefore the articles gripped by the first covering-belt system 90 are rotated through this angle of 90° during transportation in the subsidiary line 60. Instead of an angle of 90 degrees, it is also possible to provide some other angle of rotation.

FIG. 1 also shows a second gripping configuration 125, which is arranged downstream of the first gripping configuration 80—as seen in the movement direction X. The two gripping configurations are thus spaced apart from one another. By the second gripping configuration 125, those articles which the first gripping configuration 80 has not gripped on account of too low a height are gripped and fed into the subsidiary line 70, which is the lower subsidiary line in FIG. 1.

For this purpose, the second gripping configuration 125 has a second covering-belt system 130 with a second supporting belt 140 and a second covering belt 150. The second covering belt 150 is deflected by a second deflecting roller 160 which is spaced apart downstream of the first deflecting roller 120—as seen in the movement direction X. The installation height of the second deflecting roller 160 is smaller than the installation height H of the first deflecting roller 120, since the function of the second gripping configuration 125 is that of gripping relatively small or less high articles.

The second supporting belt 140 and the second covering belt 150 are twisted in each case by an angle of rotation of approximately 90°, and therefore the articles gripped by them are rotated by them through this angle of rotation of approximately 90°. The angle of rotation of the second covering-belt system 130 thus preferably corresponds to the angle of rotation of the first covering-belt system 90, and therefore the articles, which are guided separately in the two subsidiary lines 60 and 70, are aligned, or remain, at least more or less parallel to one another.

FIG. 1 further shows a free-running region 200, which is arranged upstream of the first gripping configuration 80—as seen in the movement direction X—and is thus arranged between the transporting line 40 and the first gripping configuration 80. The two supporting belts 100 and 140 of the two covering-belt systems 90 and 130 extend into the free-running region—counter to the movement direction—and form a transporting portion of the dividing-up configuration 50, the articles which are to be transported being transported in this transporting portion without any covering belt, that is to say without the cooperation of the two covering belts 110 and 150.

In order to ensure that the articles are also reliably guided, and directed further, in the free-running region 200, it is considered to be advantageous if at least one pivotable pressure-exerting element, for example in the form of a roller, is arranged in the free-running region 200, this element pushing the articles onto at least one of the two supporting belts 100 and 140. The exemplary embodiment according to FIG. 1 provides two such pressure-exerting elements, which are indicated by designations 210 and 220. The pressure-exerting elements 210 and 220 may be formed by spring-loaded and pivotably retained rollers, as will be explained in more detail, by way of example, hereinbelow. As an alternative, the pressure-exerting elements 210 and 220 may also be formed by elements which can be controlled externally and/or moved, or swung away, in some other way and preferably adapt themselves to the respective magnitude or height of the articles to which pressure is to be exerted.

FIG. 1 additionally shows a directing element 230, which is assigned to the first gripping configuration 80 and serves to assist the rotation of the articles gripped by the first covering-belt system 90 and to ensure that the articles gripped by the first covering-belt system 90 are guided past the second deflecting roller 160 of the second gripping configuration 125 without being gripped thereby. The directing element 230 thus interacts with the twisted belts of the first gripping configuration 80 in order to facilitate the operation of the gripped articles being rotated out of the gripping region of the second gripping configuration 125.

It is further evident from FIG. 1 that the two subsidiary lines 60 and 70 have arranged downstream of them a further transporting line 300, into which the two subsidiary lines 60 and 70 feed the articles transported by them.

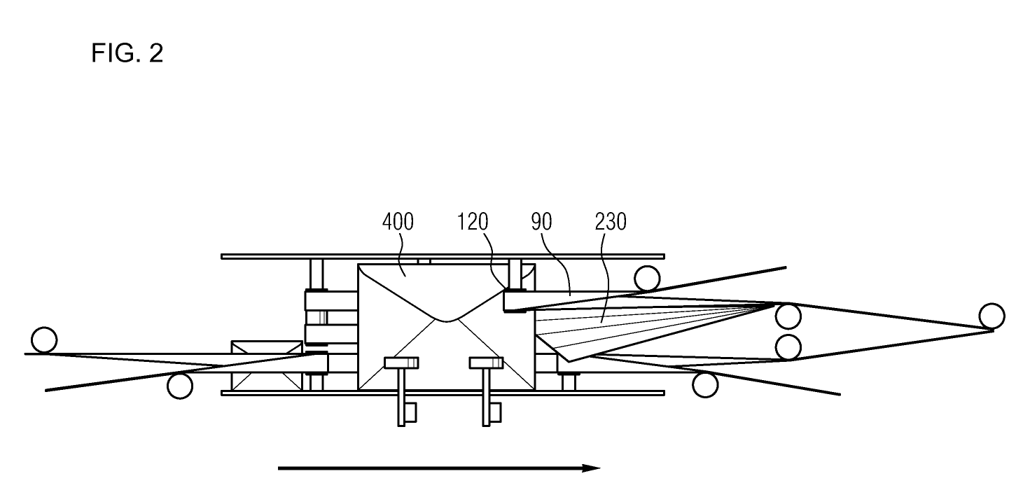

FIG. 2 shows, by way of example, the functioning of the apparatus 10 according to FIG. 1 in more specific detail. It is possible to see a relatively large or relatively high article 400, which exceeds the predetermined minimum height and is thus gripped by the first deflecting roller 120 of the first gripping configuration. In other words, the first covering-belt system 90 will grip the article 400 and, on account of the twisting of the first supporting belt and of the first covering belt, will initiate rotation of the article 400. This rotation of the article 400 is assisted, in addition, by the directing element 230, which is arranged such that it likewise rotates the article 400.

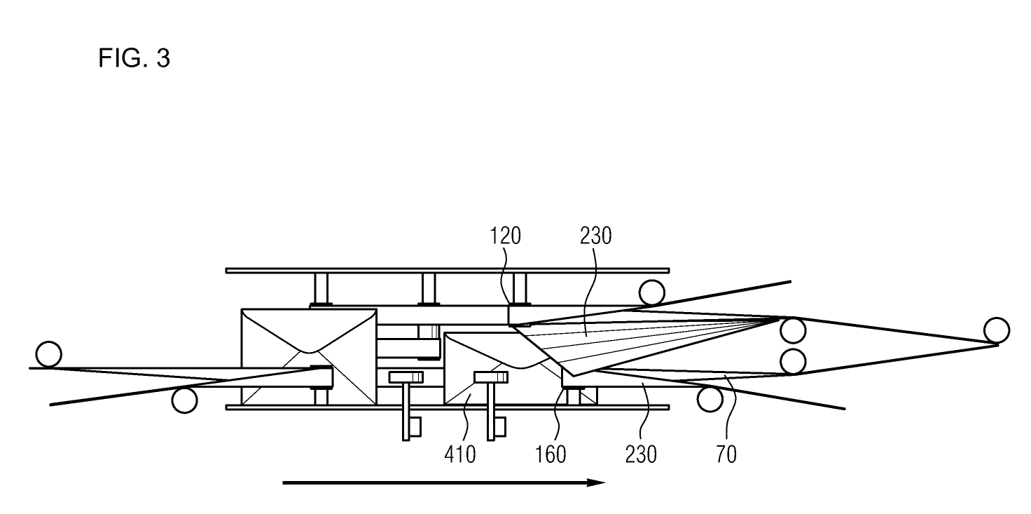

FIG. 3 shows, by way of example, the functioning of the apparatus 10 according to FIG. 1 for a small article of which the height does not reach the minimum height H. The small article is designated in FIG. 3 by designation 410. On account of its height, the article 410 is not gripped by the first deflecting roller 120, and it also runs past the directing element 230 without being affected. It is only the second deflecting roller 160 of the second covering-belt system 130 which can grip the article 410, and thus feed it into the subsidiary line 70, which is the lower subsidiary line in FIG. 3. It is also the case that the article is rotated in the lower subsidiary line 70, since the two belts of the second covering-belt system 130—in the same way as the belts of the first covering-belt system 90—are rotated through approximately 90°.

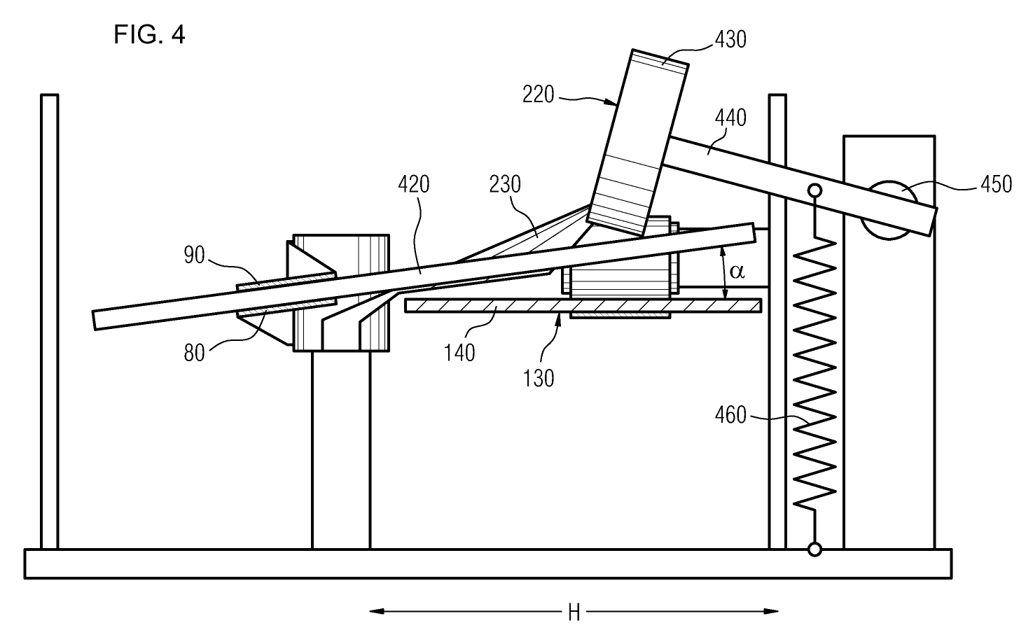

FIG. 4 shows, by way of example, the apparatus 10 according to FIG. 1 in a view along the movement direction X, as seen at location IV-IV according to FIG. 1. It is possible to see, in FIG. 4, a large or high article 420, which has been gripped by the covering-belt system 90 of the first gripping configuration 80 and has already been rotated through an angle α. At this point in time, the article 420 is still in contact with the pivotable pressure-exerting element 220 according to FIG. 1. The pressure-exerting element 220 contains a roller 430, which can be rotated about a retaining rod 440. The retaining rod 440 is retained such that it can be pivoted by a pivot bearing 450. In addition, a spring 460 interacts with the retaining rod 440, this spring pulling the retaining rod 440 downward in FIG. 4 and thus pushing it onto the article 420. The spring 460 thus results in reliable guidance of the article 420 as the article 420 is being tilted and/or rotated by the first covering-belt system 90 and the directing element 230.

It is also evident from FIG. 4 that, on account of being rotated and/or tilted, the article 420 has already lost contact with the second supporting belt 140 of the second covering-belt system 130.

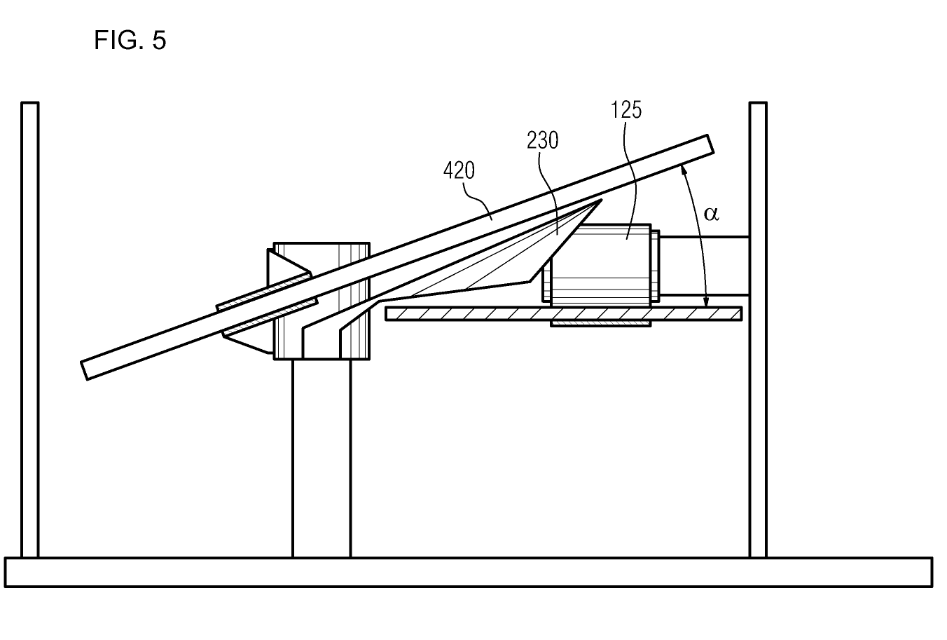

FIG. 5 shows a different view of the article 420. It can be seen that the article 420 has been pivoted yet further and has already lost contact with the directing element 230. The large angle of rotation a ensures that the article 420 is rotated out of the gripping region of the second gripping configuration 125 and, accordingly, cannot be gripped any longer by the same. The second gripping configuration 125 can thus grip only such articles as can pass the first deflecting roller, and thus the directing element 230, without being gripped by these elements in the process.

1. An apparatus for transporting articles, the apparatus comprising:
at least one transporting line;
at least two subsidiary lines; and
a dividing-up configuration connected to said transporting line and intended for dividing up the articles onto said at least two subsidiary lines disposed downstream of said dividing-up configuration, said dividing-up configuration having a first gripping configuration for gripping and rotating all of the articles having a predetermined minimum height and disposed downstream of said first gripping configuration, as seen in a movement direction, is a second gripping configuration configured to grip the articles as have passed through said first gripping configuration without being gripped, a distance between said first gripping configuration and said second gripping configuration is dimensioned such that the articles gripped by said first gripping configuration are rotated out of a gripping region of said second gripping configuration before they pass through said second gripping configuration.

2. The apparatus according to claim 1, wherein:
said first gripping configuration has a first covering-belt system with a first supporting belt and a first covering belt;
said first covering-belt system is installed at a height which corresponds to the predetermined minimum height; and
all of the articles having the predetermined minimum height are gripped by said first supporting belt or said first covering belt.

3. The apparatus according to claim 2, wherein said first supporting belt and said first covering belt are twisted by a predetermined first angle of rotation, and the articles gripped by them can be rotated by them through the predetermined first angle of rotation.

4. The apparatus according to claim 1, wherein said first gripping configuration has a directing element, and said directing element is disposed such that said directing element executes, or at least assists, an operation where the articles gripped by said first gripping configuration are rotated out of said gripping region of said second gripping configuration.

5. The apparatus according to claim 4, wherein said directing element is disposed in its entirety, or at least in part, between said first gripping configuration and said second gripping configuration.

6. The apparatus according to claim 3, wherein said second gripping configuration has a second covering-belt system with a second supporting belt and a second covering belt.

7. The apparatus according to claim 6, wherein said second supporting belt and said second covering belt are twisted by a predetermined second angle of rotation and are configured such that the articles gripped by them are rotated by them through the predetermined second angle of rotation, the predetermined second angle of rotation corresponds to the predetermined first angle of rotation through which said first supporting belt and said first covering belt can rotate the articles gripped by them.

8. The apparatus according to claim 6, wherein:
said dividing-up configuration has a free-running region disposed upstream of said first gripping configuration as seen in the movement direction; and
said first and second supporting belts of said first and second covering-belt systems extend into said free-running region and are able to carry the articles in said free-running region.

9. The apparatus according to claim 8, further comprising at least one pivotable pressure-exerting element disposed in said free-running region, said pressure-exerting element configured to push the articles onto at least one of said first and second supporting belts.

10. The apparatus according to claim 1, further comprising a further, downstream transporting line and said at least two subsidiary lines are connected to said further, downstream transporting line, into which said two subsidiary lines feed rotated articles.
